(19) United States
(12) Patent Application Publication
(10) Pub. No.: US 2011/0041427 A1
(43) Pub. Date: Feb. 24, 2011

(54) GLAZING PANEL

(75) Inventor: Olivier Bouesnard, Jumet (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC Glass Europe, Brussels (Watermael-Boitsfort) (BE)

(21) Appl. No.: 12/867,852

(22) PCT Filed: Feb. 13, 2009
(86) PCT No.: PCT/EP2009/051684

§ 371 Date: Oct. 28, 2010

(30) Foreign Application Priority Data
Feb. 15, 2008 (EP) 08151501.7
Nov. 10, 2008 (EP) 08168703.0

(51) Int. Cl. E06B 7/12; E06B 7/16; E04C 2/20

(52) U.S. Cl. 52/171.3; 52/204.593; 52/309.1

(57) ABSTRACT

An insulating glazing panel including two glass panes held in spaced apart relation by a peripherally extending assembly including a spacer (including profile lengths, corners and at least one connection) and a first sealant. The two glass panes and the assembly define a first, closed interpane space and a second, open interpane space. A second sealant is provided in the second, open interpane space and coats the assembly. The thickness of the second sealant coating the majority of the spacer's outermost points that are not at a corner or connection position is less than or equal to 1 mm; and the thickness of the second sealant adjacent to the glass panes, measured parallel to the glass panes from the spacer's outermost point level at the majority of the positions that are not a corner or a connection, is more than 1 mm.

The present invention relates to insulating glazing panels; in particular, it relates to multiple glazing units, for example double glazing units.

Multiple glazing units may offer better thermal and/or sound insulation compared to simple glazing units. Such glazing panels generally comprise two glass panes held in spaced apart relation by a peripherally extending spacer. The spacer may be a metallic or a plastic/metallic profile which is adhered to the panes, towards the periphery of the glazing, i.e. along the length of the four edges thereof. The hermetically sealed interpane space defined by the glass panes and the spacer may be filled with a gas, for example air or a noble gas, e.g. argon. The sealing may be ensured by the presence of sealant(s) between the spacer and each of the panes and/or in the interpane space extending outside of the spacer, i.e. between the spacer and the periphery of the glazing. The sealing may form a barrier to the passage of moisture vapour, water and/or gas and offer mechanical resistance to the glazing panel. FIG. 1 is a schematic cross-section of a portion of an insulating glazing panel according to the prior art. Two glass panes (1, 1′) are held in spaced apart relation by an assembly (2) comprising a spacer (3) and a first sealant (4). This defines a first, hermetically sealed interpane space (5) and a second, open interpane space (6) extending outside of the assembly. The second interpane space (6) is substantially filled with a second sealant (7).

According to one of its aspects, the present invention provides an insulating glazing panel as defined by claim 1. Dependent claims define preferred and/or alternative aspects of the invention.

The invention provides a new insulating glazing structure which may offer insulating and mechanical resistance properties at least as good as previous known structures, but comprising less sealant material, which may be cost effective and/or more rapid to manufacture. Indeed, as the amount of second sealant may be significantly less than in prior art embodiments, this may allow using faster sealant delivery means in the manufacturing process.

Furthermore, the present invention may apply to insulating glazing structures wherein simple shaped spacers are used. Indeed, we have found that the use of less sealant does not necessarily require the use of complex shaped spacers. Such complex spacers may have the disadvantage of being more expensive and/or more difficult to fold (thereby decreasing the manufacturing line rate) and may need more complex sealant delivery machines.

Insulating glazing panels according to the invention comprise two glass panes held in spaced apart relation by a peripherally extending assembly comprising a spacer and a first sealant. The spacer includes profile lengths, corners and one or more connections. Spacers are generally provided as long profiles; in order to integrate them in a rectangle glazing panel, for example, it may be necessary to bend the profile to form a rectangle shape and ensure a connection between the ends of the profile, or to use four distinct lengths of profile and ensure connections at the corners with specific corner pieces.

The two glass panes and the assembly according to the invention define a first, closed interpane space and a second, open interpane space, said second interpane space extending outside of the assembly, facing the exterior.

In glazing panels according to the invention, a second sealant is provided in the second, open interpane space and coats the assembly. Along the major part of the spacer (excluding corners and connections), i.e. along at least more than 50%, preferably more than 60% or 70% or still more preferably more than 80% or 90% of the spacer's length (excluding corners and connections), the thickness of the second sealant coating a spacer's outermost point (t_{b}) is less than or equal to 1 mm; and the thickness of the second sealant adjacent to the glass panes (tₑ), when measured parallel to the glass panes from the spacer's outermost point level, is more than 1 mm or preferably more than 1.5 mm. Thicknesses t_{b} and tₑ may be measured every 5 cm along the periphery of the glazing panel (excluding corners and connections) and more than 50%, preferably more than 60% or 70% or still more preferably more than 80% or 90% of the measurements results are less than or equal to 1 mm for t_{b} and more than 1 mm, or preferably more than 1.5 mm, for tₑ.

This particular shape for the second sealant may provide good insulating and mechanical resistance properties to the insulating glazing panel, whilst using less sealant material. In particular embodiments of the invention, it has been possible to reduce the quantity of sealant by up to 75% compared to prior art configurations and still obtain good properties for the insulating glazing panel. On corners and connections, the thickness of the second sealant coating a spacer's outermost point is preferably less than or equal to 3.5 mm.

Advantageously, the first sealant may be highly water impermeable and preferably comprises a material having a gas permeability equal to or less than 0.002 g/m²·h and a moisture vapour transmission rate (MVTR) equal to or less than 0.6 g/m²·h for a 2 mm thick membrane (measured according to EN1279-4). The first sealant may mainly ensure that the first, closed interpane space is hermetically sealed and is maintained in a dry state in order to avoid any condensation of water at the interior of the glazing panel. The first sealant may also ensure a first adhesion of the spacer to the glass panes. Preferably, the first sealant is a polyisobutylene (PIB) type, one component, thermoplastic sealant, which may comprise PIB and/or butyl rubber; it may more preferably consists essentially of butyl rubber. In one preferred embodiment, the first sealant may be positioned as a layer of sealant between the spacer and each of the glass panes.

Advantageously, the second sealant may be adhesive and relatively rigid. Preferably, the second sealant has a shore A hardness equal to or greater than 40. This may ensure that the two panes are firmly maintained in face-to-face relationship and do not separate from each other when they are subjected to stresses due to changes in temperature for example. The second sealant may also participate, together with the first sealant, in ensuring a correct barrier against the passage of moisture vapour, water and/or gas. Preferably, the second sealant comprises, or more preferably consists essentially of, at least one material selected from the group consisting of polysulfides, polyurethanes, silicones and reactive hotmelt (i.e. thermoplastic sealant with moisture curing parts).

It may be advantageous for the second sealant to have, along the major part of the spacer (excluding corners and connections), a thickness or a height (h) adjacent to the glass panes, measured parallel to the glass panes from the first sealant's outermost point level, greater than tₑ. This may help ensure the mechanical resistance of the insulating glass double sealant barrier (particularly between the glass panes and the spacer), which may be subjected to stress because of relative movements between glass and spacer due to, for example, wind, temperature variations, snow or vibrations in the glazing panel.

In a preferred embodiment, the second sealant coats the surfaces of the glass panes facing the second, open interpane space but is arranged to leave an uncoated distance of at least 1 mm, more preferably at least 2 mm, measured from the glass panes edges. The outermost surfaces of the glass panes facing the second, open interpane space may consequently be left uncoated. This may ensure that the second sealant is confined inside the interpane space which may help keep the edges of the glass panes clean. Another advantage may be seen on the manufacturing line when assembled glass panes are placed on racks: the risk of adhering on the support, therefore damaging the outer sealant, may be minimised.

Insulating glazing panels according to the invention may preferably have a moisture penetration index I according to EN1279-2 equal to or less than 20%, more preferably equal to or less than 10%. Gas-filled insulating glazing panels according to the invention may preferably have a gas leakage according to EN1279-3 equal to or less than 1% per year.

Spacers which may be used with the present invention include spacers having a relatively simple shape and spacers of the type “warm edge”, i.e. providing increased thermal insulating properties; they may be made of metal, e.g. steel, or made of a combination of plastic and metal or plastic and stainless steel for example. Preferably the spacer is designed to provide sufficient contact surface with the second sealant and/or to help the flow of second sealant during the extrusion of the second sealant itself, which may decrease the risk for bubbles to be trapped between first and second sealants. The connection between the spacer's ends may be made by welding; or each end of the spacer may be integrated in a straight connector or a corner piece. Such connectors may themselves include a sealant (e.g. butyl rubber) to provide better resistance to ingress of moisture at these specific connection locations, which generally are weak points along the peripheral seal of the glazing. At connections' position, a vapour barrier e.g. butyl tape, metallised tape or polymeric membrane with low gas and vapour permeability, may be applied to ensure a good seal.

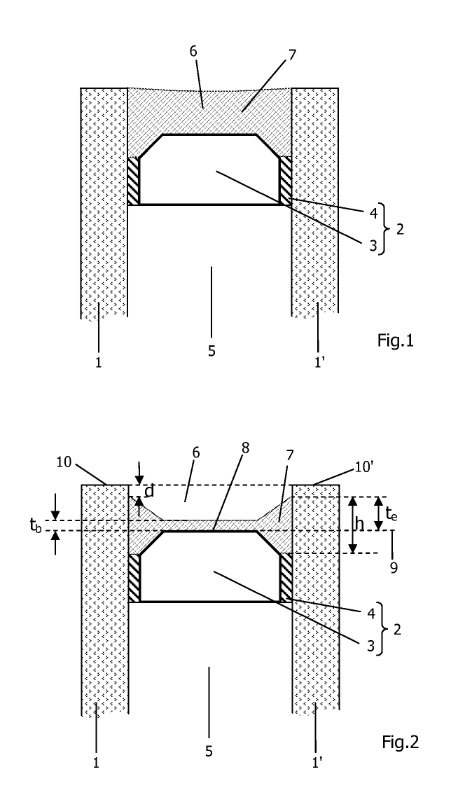

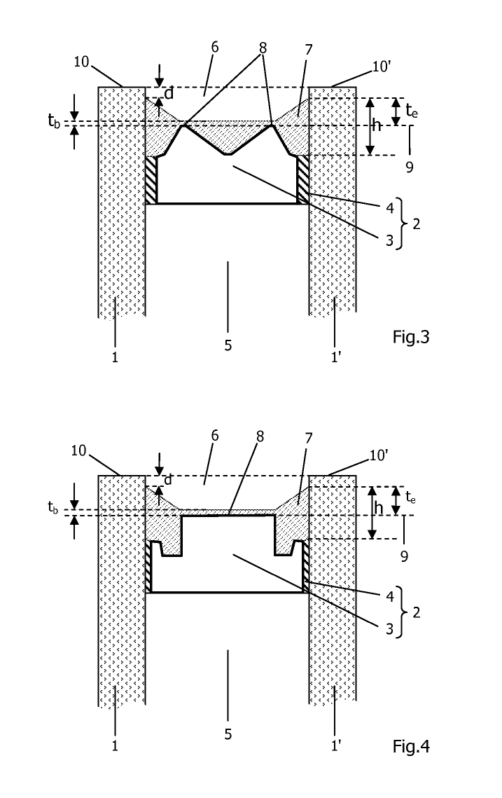

Embodiments of the invention will now be described, by way of example only, with reference to FIGS. 2 to 4 and to examples 1 to 10, along with comparative examples 1 to 5.

FIGS. 2 to 4 are schematic cross-sections of a portion of insulating glazing panels according to the invention.

They show two glass panes (1, 1′) held in spaced apart relation by an assembly (2) comprising a spacer (3) and a first sealant (4). This defines a first, closed interpane space (5) and a second, open interpane space (6) extending between the assembly and the periphery of the glazing panel. The second interpane space (6) is partially filled with a second sealant (7). Various shapes for the spacer are shown in these figures. The second sealant (7) coats the assembly (2) such that the thickness (t_{b}) of the second sealant (7) coating a spacer's outermost point (8) shown in the figures is less than or equal to 1 mm and the thickness (tₑ) of the second sealant (7) adjacent to the glass panes (1, 1′), measured parallel to the glass panes (1, 1′) from the spacer's outermost point level (9) shown in the figures, is more than 1 mm. In the embodiments of the invention shown in FIGS. 2 to 4, the second sealant (7) coats the surfaces of the glass panes (1, 1′) facing the second, open interpane space (6) up to a distance (d) of at least 1 mm measured from the glass panes edges (10, 10′) and has a height (h) adjacent to the glass panes, measured parallel to the glass panes from the first sealant's outermost point level, greater than tₑ.

### EXAMPLES

Examples 1 to 6 are insulating glazing panels with a spacer made of steel having a shape as shown in FIG. 2 and a height of 7.2 mm. The distance between the glass panes is 12 mm. The thickness of the second sealant coating the spacer's outermost surface, t_{b}, is 0.2 mm, the thickness of the second sealant adjacent to the glass panes, as defined herein, tₑ, is 3.5 mm and h is greater than tₑ. In examples 1 to 3, the second sealant consists essentially of polyurethane. In example 1, the spacer's connection is made by welding; in example 2 this is also the case but the connection is furthermore protected by a butyl cord; in example 3 the connection is made by a connection piece filled with butyl rubber. In examples 4 to 6, the second sealant consists essentially of polysulfide. In example 4, the spacer's connection is made by welding; in example 5 this is also the case but the connection is furthermore protected by a butyl tape; in example 6 the connection is made by a connection piece filled with butyl rubber.

Example 7 is identical to example 4, except that t_{b} is 1 mm. Example 8 is identical to example 6, except that t_{b} is 1 mm.

Example 9 is identical to example 3, except that the spacer is a warm-edge spacer made of plastic and stainless steel and having a shape as shown in FIG. 4, with a height of 7 mm. Example 10 is identical to example 6, except that the spacer is identical to the spacer of example 9.

Moisture penetration indexes I were measured according to EN1279-2 on the glazing panels of examples 1 to 10. This gives an indication of the resistance of the glazing panel to the ingress of moisture. Three measurements were made for each example. The mean I indexes are given in Table I. The EN1279-2 standard specifies that I should not exceed 20%. All the results obtained for examples 1 to 10 show very good values for the I index, fulfilling easily the EN1279-2 standard requirements.

Gas leakage measurements were made according to EN1279-3 on the glazing panels of examples 1 to 10 which were filled with argon. Results of these tests were in accordance with the limit defined by the standard, which is a gas leakage not exceeding 1% per year. Mean gas leakage values for examples 7 and 8 were respectively 0.78 and 0.84% per year, for example. By comparison, a glazing panel not in accordance with the present invention, identical to example 8 but with a t_{b} of 3.5 mm, shows a mean gas leakage value of 0.75.

### Comparative Examples

Comparative example 1 is identical to example 1 except that t_{b} is 3.5 mm. Comparative example 2 is identical to example 3 except that t_{b} is 3.5 mm. Comparative example 3 is identical to example 4 except that t_{b} is 3.5 mm. Comparative example 4 is identical to example 9 except that t_{b} is 3.5 mm. Comparative example 5 is identical to example 10 except that t_{b} is 3.5 mm. Mean I index values for the comparative examples are given in Table I.

All the comparative examples show similar results for the moisture penetration index I than examples according to the present invention. This demonstrates that glazing panels according to the present invention may offer, with less sealant, similar durability and thus similar insulating properties than previous known glazing panels.

TABLE I
Mean I indexes (expressed in %) measured according to EN1279-2

| | | | | polyurethane | | | polysulfide | | |
|---|---|---|---|---|---|---|---|---|---|
| | | | | | welded connection | connector | | welded connection | connector |
| | 2nd sealant consisting essentially of: | | | welded | protected by | filled with | welded | protected by | filled with |
| | spacer | t_{b} | tₑ | connection | butyl cord | butyl rubber | connection | butyl cord | butyl rubber |
| ex 1 | steel | 0.2 mm | 3.5 mm | 3.3 | | | | | |
| ex 2 | steel | 0.2 mm | 3.5 mm | | 1.7 | | | | |
| ex 3 | steel | 0.2 mm | 3.5 mm | | | 3.5 | | | |
| ex 4 | steel | 0.2 mm | 3.5 mm | | | | 3.6 | | |
| ex 5 | steel | 0.2 mm | 3.5 mm | | | | | 2.3 | |
| ex 6 | steel | 0.2 mm | 3.5 mm | | | | | | 2.2 |
| ex 7 | steel | 1 mm | 3.5 mm | | | | 1.2 | | |
| ex 8 | steel | 1 mm | 3.5 mm | | | | | | 2.5 |
| ex 9 | warm-edge | 0.2 mm | 3.5 mm | | | 6.0 | | | |
| ex 10 | warm-edge | 0.2 mm | 3.5 mm | | | | | | 4.7 |
| comp | steel | 3.5 mm | 3.5 mm | 2.8 | | | | | |
| ex 1 | | | | | | | | | |
| comp | steel | 3.5 mm | 3.5 mm | | | 5.3 | | | |
| ex 2 | | | | | | | | | |
| comp | steel | 3.5 mm | 3.5 mm | | | | 0.83 | | |
| ex 3 | | | | | | | | | |
| comp | warm-edge | 3.5 mm | 3.5 mm | | | 7.5 | | | |
| ex 4 | | | | | | | | | |
| comp | warm-edge | 3.5 mm | 3.5 mm | | | | | | 2 |
| ex 5 | | | | | | | | | |

1-13. (canceled)

14. An insulating glazing panel comprising:
two glass panes held in spaced apart relation by a peripherally extending assembly comprising a spacer, including profile lengths, corners and at least one connection, and a first sealant, the two glass panes and the assembly defining a first, closed interpane space and a second, open interpane space, wherein
(i) a second sealant is provided in the second, open interpane space and coats the assembly;
(ii) the thickness of the second sealant coating the majority of the spacer's outermost points which are not at a corner or connection position is less than or equal to 1 mm; and
(iii) the thickness of the second sealant adjacent to the glass panes, measured parallel to the glass panes from the spacer's outermost point level at the majority of the positions which are not a corner or a connection, is more than 1 mm.

15. An insulating glazing panel according to claim 14, wherein the thickness of the second sealant adjacent to the glass panes is more than 1.5 mm.

16. An insulating glazing panel according to claim 14, wherein the second sealant has a height adjacent to the glass panes, measured parallel to the glass panes from the first sealant's outermost point level, greater than the thickness of the second sealant.

17. An insulating glazing panel according to claim 14, wherein the first sealant comprises a material having a gas permeability equal to or less than 0.002 g/m²·h and a moisture vapour transmission rate (MVTR) equal to or less than 0.6 g/m²·h for a 2 mm thick membrane.

18. An insulating glazing panel according to claim 14, wherein the first sealant comprises polyisobutylene (PIB).

19. An insulating glazing panel according to claim 14, wherein the first sealant consists essentially of butyl rubber.

20. An insulating glazing panel according to claim 14, wherein the second sealant has a shore A hardness equal to or greater than 40.

21. An insulating glazing panel according to claim 14, wherein the second sealant comprises at least one material selected from the group consisting of polysulfides, polyurethanes, silicones, and reactive hotmelt.

22. An insulating glazing panel according to claim 14, wherein the second sealant is arranged to coat a portion of the surfaces of the glass panes facing the second, open interpane space and to provide an uncoated portion extending a distance of at least 1 mm measured from the glass panes edges.

23. An insulating glazing panel according to claim 22, wherein the uncoated portion extends a distance of at least 2 mm.

24. An insulating glazing panel according to claim 14, having a moisture penetration index I according to EN1279-2 equal to or less than 20%.

25. An insulating glazing panel according to claim 24, wherein I is equal to or less than 10%.

26. An insulating glazing panel according to claim 14, filled with gas and having a gas leakage according to EN1279-3 equal to or less than 1% per year.
